(19) United States
(12) Patent Application Publication
(10) Pub. No.: US 2016/0019635 A1
(43) Pub. Date: Jan. 21, 2016

(54) ONE VIEW USER INTERFACE

(71) Applicants: Bikash Mohanty, Mumbai (IN); Sidharth Khanna, Mumbai (IN)

(72) Inventors: Bikash Mohanty, Mumbai (IN); Sidharth Khanna, Mumbai (IN)

(21) Appl. No.: 14/867,365

(22) Filed: Sep. 28, 2015

Related U.S. Application Data
(63) Continuation-in-part of application No. 14/322,068, filed on Jul. 2, 2014.

(30) Foreign Application Priority Data
Mar. 12, 2014 (IN) 827/MUM/2014

(51) Int. Cl. G06Q 30/06; G06F 3/0482; G06F 3/0484; G06F 17/30

(52) U.S. Cl. CPC G06Q 30/0641; G06F 17/30528; G06F 3/0482; G06F 3/0484

(57) ABSTRACT

A one view user interface system for enabling prolific viewing of products and related information is described. The one view system user interface includes: a consolidated view of supplier, category or business unit on one platform encompassing information about its spend, contracts, supplier performance programs, sourcing events and purchase orders/invoices in order to enable the user to view information pertaining to supplier, category and/or business unit. The system avoids the user having to log in into different product portals to view related information or data, thereby helping the user to know the supplier related information while remaining in any one of the procurement tools and the user is not required to switch over from one product to another product.

### CROSS-REFERENCE TO RELATED APPLICATION

The instant application is a continuation in part of U.S. patent application Ser. No. 14/322,068 filed Jul. 2, 2014, pending, and claims priority to Indian Patent Application Serial No. 827/MUM/2014, filed Mar. 12, 2014, pending, the entire specifications of both of which are expressly incorporated herein by reference.

### FIELD OF THE INVENTION

The present invention relates generally to computer user interfaces, and more particularly, to a “one view” user interface system for enabling prolific views of products and their related information.

### BACKGROUND OF THE INVENTION

Business procurement tools such as electronic auctions, e-procurement systems, supplier information systems, supplier performance systems, contract management systems, spend analyzation tools, typically contain data in accordance with the functionality of their respective tools.

The user, at times, may find it difficult to login into different products to see the related data of a supplier. For example, the user may need to log in into a supplier performance management (SPM) system to find out the supplier performance data, or need to log in into a contract management tool to find out the contracts of the supplier, or need to log in into a supplier information management (SIM) system to know the supplier related info, or else the user has to switch over from one product to another to know the related supplier information.

Most, if not all, of the product and/or supplier information needed by the user is typically accessed via network-enabled computing devices with graphical user interfaces. Network-enabled computing devices with graphical user interfaces, such as computer workstations and cellular telephones, often provide users with a web browser to view and interact with Internet web pages. Web pages are often defined by the website developer to be displayed in a specific manner that may not be ideal for all users. Some web browsers provide users with the ability to override certain functions and attributes of web pages, such as preventing the display of distracting advertisements. However, current web browsers are incapable of displaying just the portions of web pages a user selects and/or the prolific view as desired in product based displays.

In order to overcome the problems associated as discussed in background, there exists a need to provide a system, and method for using same, whose functionality is not restricted to a particular sector of the commercial industry, but which can be used for multiple applications.

Therefore, there exists a need to provide a “one view” feature, whereby the user may access the webpage to obtain more detailed and relevant information.

### SUMMARY OF THE INVENTION

An object of the invention is to have a one view user interface system for enabling prolific views of products and their related information.

Yet another object of the present invention is to depict all (or most) of the product related information and provide same to the user in order to perform procurement performance analysis.

Yet another object of the present invention is to have a one view user interface system on a mobile device such that the user is not at all required to log in into different procurement tools, but can access the one view data of the supplier directly through mobile apps.

It is a further object of the present invention to provide a consolidated view of the supplier, category and/or business unit on one platform encompassing information about its Spend, Contracts, Supplier Performance Programs, Sourcing Events and Purchase Orders/Invoices using the one view system.

The one view features of the present invention solve the difficulty of the system needing to depict all the related supplier information to the user while the user is in any of the procurement performance products.

For example, if the user is in the SIM system, and the user causes the screen cursor to hover over the supplier name, the user will be able to view in a window all the related supplier information at a glance. That is, the one view system will depict supplier location, contracts with suppliers, spend related data to the supplier and the contracts related to the supplier. This one view feature of the present invention helps the user to know the supplier related information while remaining in any one of the procurement tools and the user is not required to switch over from one product to another product.

Furthermore, the view feature of the present invention may also be provided through mobile applications (i.e., “apps”) in conjunction with mobile telecommunication devices. Thus, in accordance with the general teachings of the present invention, the user is not at all required to log in into different procurement tools, but rather may access the one view data of the supplier directly through mobile apps.

The one view feature of the present invention provides a consolidated view of the supplier for any supplier name, or if the user hovers his/her cursor over the category of spend and services, then it would show a consolidated view of the suppliers for those categories or business units. Thus, the one view feature of the present invention covers suppliers, category and business unit.

In accordance with one aspect of the present invention, a “one view” system is provided. The “one view” system is a feature that provides a consolidated view of supplier, category or business unit on one platform encompassing information about its spend, contracts, supplier performance programs, sourcing events, purchase orders/invoices and/or the like.

In accordance with illustrative embodiment of the present invention, a system for providing a consolidated view is provided, wherein there is an interconnection of at least one configurable and namable business process element, comprising:

a host computer system;

at least one database component associated with the host computer system; and

a communication interface for accessing the host computer system from a plurality of remote input/output devices to manage consolidated view for the business process element.

In accordance with one aspect of this illustrative embodiment, the system may contain one or more different procurement tools, with the ability of the user to switch over from one procurement tool to another procurement tool.

In accordance with another aspect of this illustrative embodiment, the user, e.g., through a mobile device, may access any one procurement tools for a first view (e.g., a viewing of different suppliers and business units as depicted in any one procurement tool) of a supplier category and business units available on the procurement tool, with the ability of the system to covert the first view into a second view, i.e. a “consolidated” view (e.g., an aggregated/consolidated display of all (or the most) relevant information (e.g., spend, contracts, supplier performance programs, sourcing events, purchase orders/invoices and/or the like) associated with that supplier or business unit present in any and/or all other procurement tools) for that particular supplier category and business unit.

That is, the system of the present invention, and its related methodology, permits the conversion of the first view into a second or consolidated view that permits the user being able to view supplier category and or business unit depicted on any one procurement tool. For example, with respect to an electronic sourcing management tool, the user, by causing his/her cursor to hover over the location of the items mentioned such as the supplier or business unit on the input/output device system, the user triggers a request via the input/output device for a consolidated view. This request is received, e.g., at one or more processors, and is recognized as a request for a consolidated view of any supplier category or a business unit from a client device. The processors then determine a consolidated view for that supplier category or business unit. The consolidated view is then displayed for the user to view. The consolidated view may include a profile based on an aggregated display of spend, contracts, supplier performance programs, sourcing events, purchase orders/invoices and/or the like associated with that supplier category or business unit indicative of aggregated information of all, or most, of the other procurement tools. The procurement tools may include a set of procurement systems and methods for procuring any item or service. The set of procurement tools may include a cluster or series of other procurement tools which may include an electronic sourcing procurement tool, contract management procurement tool, supplier management procurement tool, e-procurement procurement tool, spend management procurement tool and/or the like. Each such procurement tool may consist of different information associated with the supplier and business units.

In accordance with another illustrative embodiment of the present invention, an integrated system for providing a consolidated view of multiple windows on a display device is provided, wherein there is at least one configurable and namable business process element operable to be displayed on the display device, comprising:

a host computer system;

at least one database component operably associated with the host computer system;

a communication interface for accessing the host computer system from a plurality of remote input/output devices, wherein the input/output devices are operable to manage the consolidated view for the business process element;

a processor unit operably associated with the host computer system; and

a computer readable medium storing instructions executable by the processor unit, the computer readable medium comprising:
an accessing system for accessing, through one of the remote input/output devices, a first view of a supplier category or business unit information set on a display device of the remote input/output devices; and
a converting system for converting the first view of the supplier category or business unit information set to a second view of the supplier category or business unit information set on the display device of the remote input/output devices;
wherein the second view of the supplier category or business unit information set includes additional or different supplier category or business unit information than the first view of the supplier category or business unit information.

In accordance with an aspect of this second illustrative embodiment, the converting system converts the first view of the supplier category or business unit information set to the second view of the supplier category or business unit information set on the display device of the remote input/output devices in response to a graphical user interface being positioned over a specified location of the display device of the remote input/output devices.

In accordance with an aspect of this second illustrative embodiment, the positioning of the graphical user interface over a specified location of the display device of the remote input/output devices causes the processor unit to generate the second view of the supplier category or business unit information set on the display device of the remote input/output devices.

In accordance with an aspect of this second illustrative embodiment, the first view of the supplier category or business unit information set and the second view of the supplier category or business unit information set on the display device of the remote input/output devices are displayed in separate windows on the display device of the remote input/output devices.

In accordance with an aspect of this second illustrative embodiment, the first view of the supplier category or business unit information set and the second view of the supplier category or business unit information set on the display device of the remote input/output devices are simultaneously displayed in separate windows on the display device of the remote input/output devices.

In accordance with an aspect of this second illustrative embodiment, the first or second view of the supplier category or business unit information set provides any one of a supplier report card, a supplier location on a map, a comment box and a date range selection system.

In accordance with an aspect of this second illustrative embodiment, the first or second view of the supplier category or business unit information set provides a date range selection system.

In accordance with an aspect of this second illustrative embodiment, a report generation system is provided, wherein a user has an option a supplier report in either a summary mode or a detail mode.

In accordance with an aspect of this second illustrative embodiment, the first or second view of the supplier category or business unit information set provides an information card, wherein the information card provides information on any one of spend, contracts, supplier performance programs, sourcing events, purchase orders, and invoices for a selected time frame for a user specific supplier, category or business unit.

In accordance with an aspect of this second illustrative embodiment, the second view of the supplier category or business unit information set provides a restricted viewing option preventing vi ring of the second view of the supplier category or business unit information set to unauthorized users.

For example, the user could manage an element of the system and method for providing a consolidated view of a product and/or supplier information on a display device (e.g., the screen) of the handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

Other features and embodiments are described further below. It nvU| be understood that the present invention may be implemented in a variety of data processing systems, such as general purpose computers, handheld computers, embedded systems, cellular telephones, and other consumer electronic devices. It will also be understood that the present invention may be implemented in software which is stored on a computer readable medium which will cause a data processing system to perform one or more of the methods described herein.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is an illustrative screen capture of a one view search box of the present invention, wherein the user may search a desired product and its specific information;

FIG. 2 is an illustrative screen capture of key elements of the one view system of the present invention, featuring a supplier report card, location through a map, comment box and date range selection;

FIG. 3 is an illustrative screen capture of a summary and detail mode of the one view system of the present invention;

FIG. 4 is an illustrative screen capture of information cards of the one view system of the present invention;

FIG. 5 is an illustrative screen capture of a restricted view within the one view system of the present invention; and

FIGS. 6A, 6B and 6C are illustrative schematics and/or flow diagrams of the one view system work flow of the present invention.

The same reference numerals refer to the same parts throughout the various Figures.

### DETAILED DESCRIPTION OF THE INVENTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers the BLACKBERRY™ and TREO™ devices), multimedia Internet enabled cellular telephones (e.g., the BLACKBERRY STORM™, and similar personal electronic devices that include a wireless communication module, processor and memory.

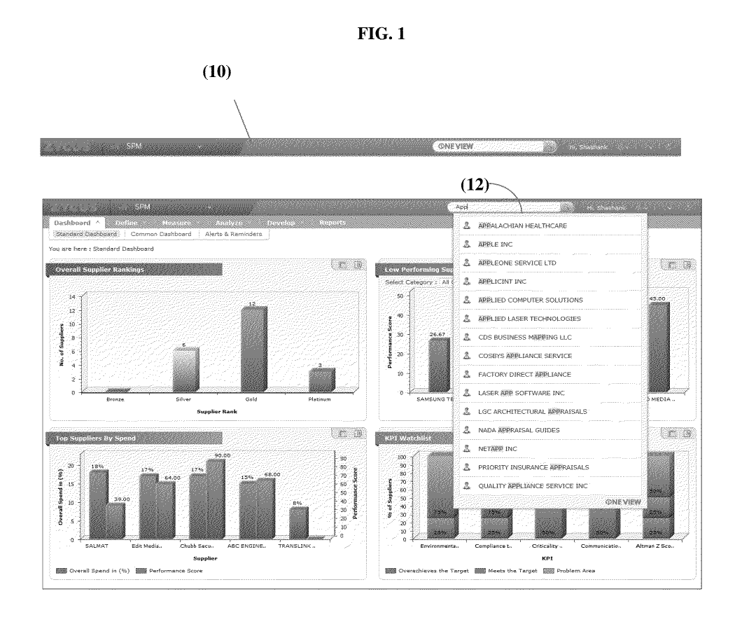

As generally shown in FIG. 1, there is generally provided a one view search box (10) in order to enable user to view information pertaining to a supplier, category or business unit. The system avoids requiring the user to log in into different product portals to view related information or data, thereby helping the user to know the supplier related information while remaining in any one of the procurement tools. That is, the user is not required to switch over from one product to another product.

Again, as generally shown in FIG. 1, the user can make use of a search tool (12) that provides a consolidated view of the supplier, category or business unit on one platform encompassing information about its spend, contracts, supplier performance programs, sourcing events and purchase orders/invoices.

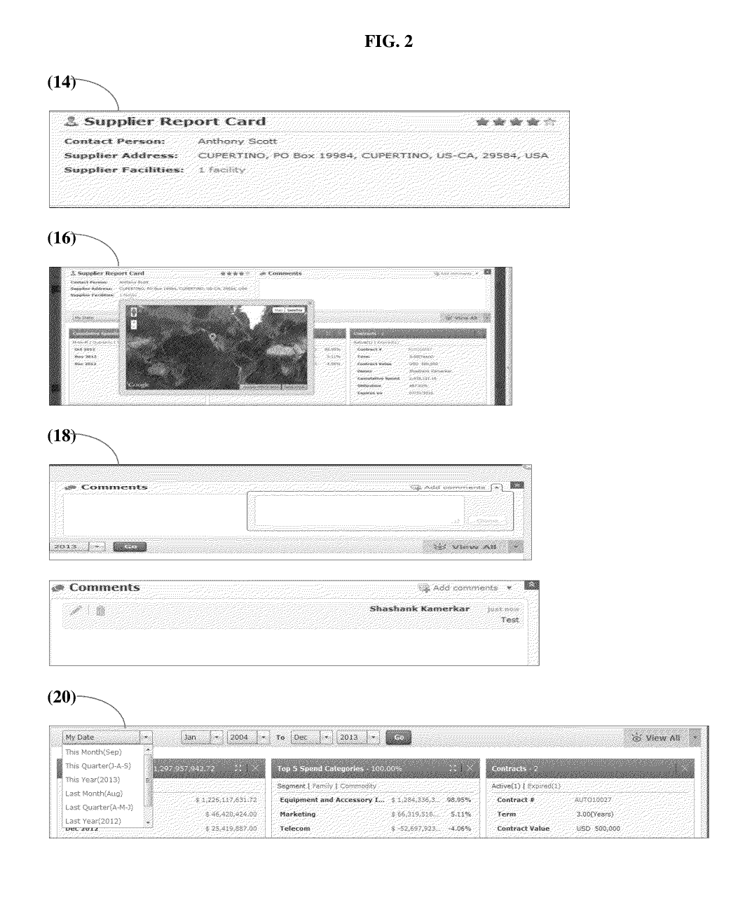

The key elements of the one view system, as generally shown in FIG. 2, provide, among other things, a supplier report card, location through a map, comment box and date range selection. The one view system displays the supplier information fetched from the supplier information management system at the top, as generally shown in FIG. 2. Attribute and performance scores (14) of the supplier have been shown by attributing stars (or any other indicia) at the right top corner (or other desired location) of the supplier report card. The supplier report card information is based on the supplier performance score for the supplier from the latest supplier performance program. The user also has the ability to allocate stars based on his/her experience and perception of the supplier report card.

Furthermore, FIG. 2 also generally depicts the provision of providing the location of the supplier through a map (16), provided of course that the address of the supplier is recorded and/or available. Therefore, if the user, while performing a search, put category or business unit and a category report or business unit report card, then the user will get the respective report card to view.

Another feature that the one view system provides, again as generally shown in FIG. 2, is a comment box (18) and date range selection by the user, whereby the user can use the comment box for adding comments about the supplier, category and/or business unit. The user can then edit and/or delete comments posted by him/her, as well as respond to the comments posted in the comment box in relation to the relevant supplier, category and/or business unit. Furthermore, the user may use a date filter option that enables him/her to select a specific time frame from a default setting. Again as generally shown in FIG. 2, the date range may be manually selected from a date filter that may display, e.g., a “My Date” option (20) that is a user specific option, whereby the default selected date range taken is of the current year. Alternately, the date ranges selected by the user may always appear as a default date range for the respective users.

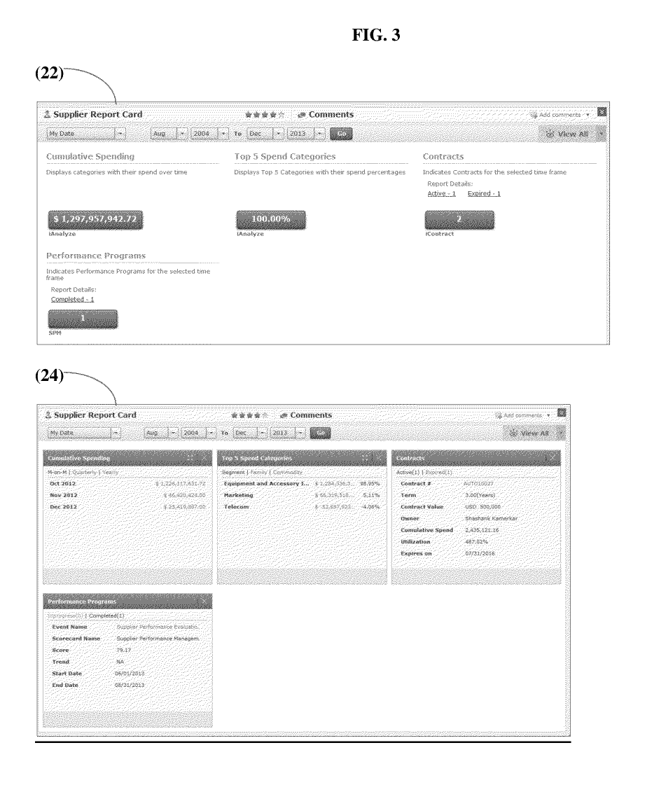

Optionally, the user may choose to have view all options that opens the entire card simultaneously when the view is in summary mode (22), e.g., as generally shown in FIG. 3. Therefore, it provides both a summary, as well as a detail unode (24), of the supplier report card.

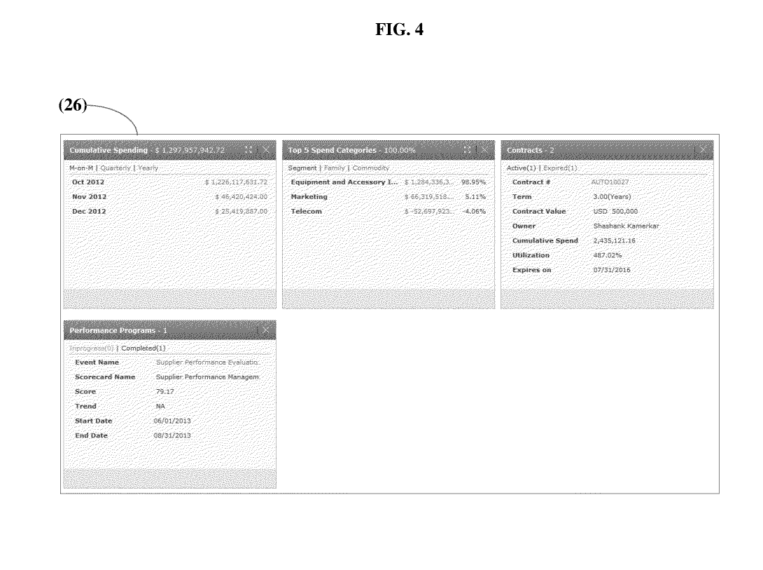

FIG. 4 generally illustrates the information cards (26) that are nothing more than the information displayed in the one view system. Thus, the information card provides, among other things, information on spend, contracts, supplier performance programs and/or sourcing events, such as, but not limited to, purchase orders and/or invoices for a selected time frame for the user specific supplier, category and/or business unit.

Again, as generally shown in FIG. 4, the user is able to view cumulative spending cards and, for example, the top five (5) spend categories through a power analysis report for a specified period of time for a desired supplier in the form of a detailed analysis. Similarly, the user is able to view a contract of a respective supplier, subject to availability and/or access to the information. The user is also able to view a supplier performance under an event name category.

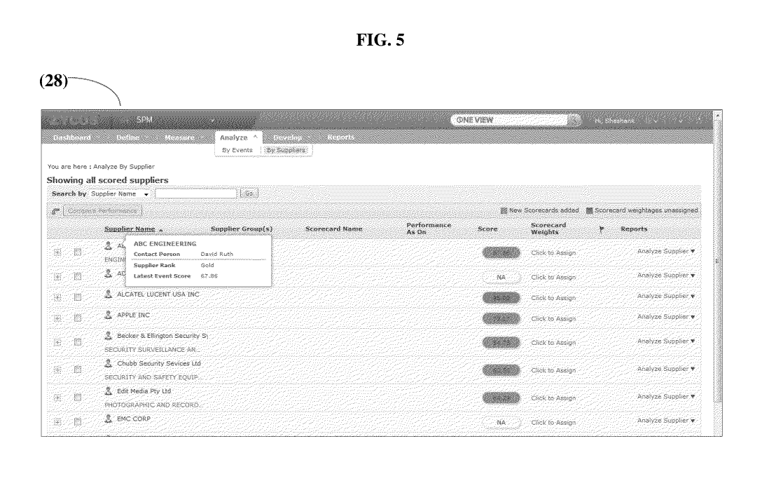

The one view system is also able to provide a restricted view (28) option, whereby the consolidated view of any supplier is user specific and a restricted view, such as cotractual details, is not visible to an unauthorized user (e.g., as generally shown in FIG. 5). Similarly, based on other decision rules, there is restriction feature within the consolidated view. However, there is a provision to have an approval from the user's manager to access the restricted views, whereby the user is then able to view all the desired details, and such approval logs may be tracked by an appropriate tool of the system.

As previously noted, the one view system may be deployed on mobile device and is available on ANDROID′ and iOS™ enabled handheld devices.

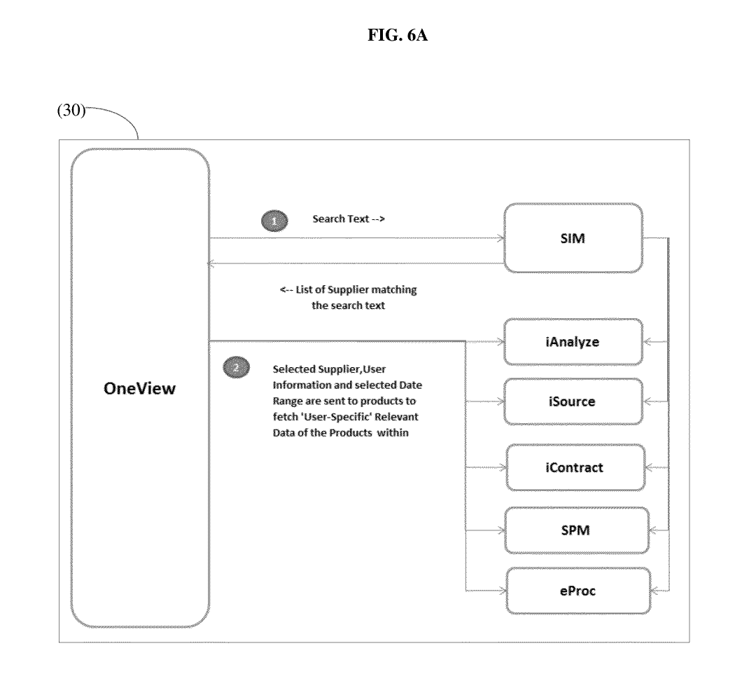

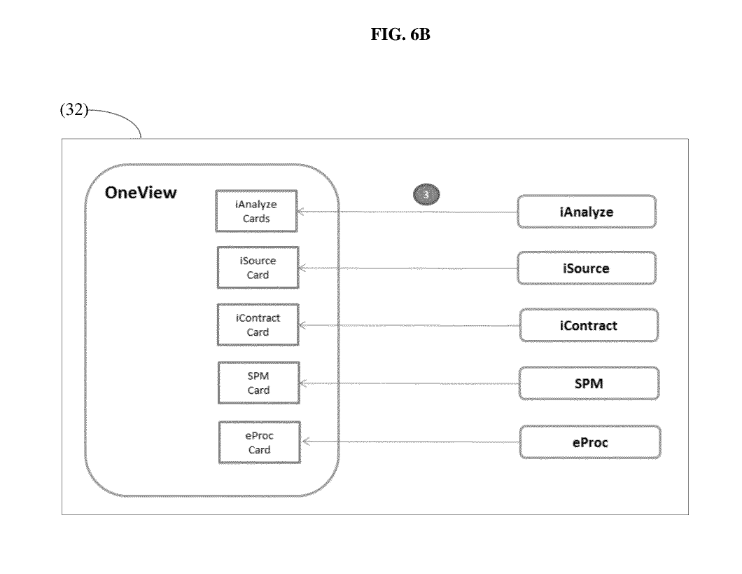

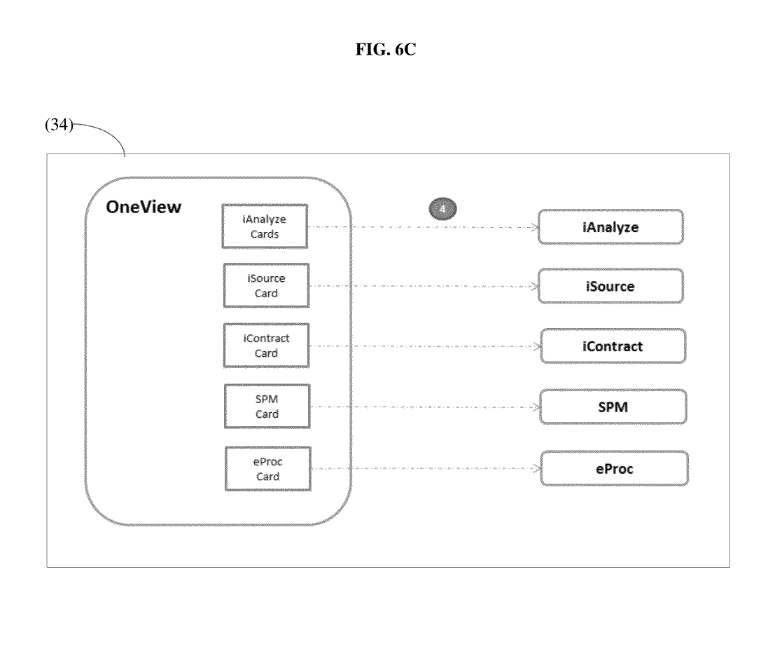

A method for implementing the system is also provided, e.g., as generally shown in FIGS. 6A-6C, wherein the one view system enables the user to fetch pertinent information from various products that gets filtered through user restricted view decision rules before getting displayed to the user. Thus, the restricted decision rules are user configurable.

Again, as generally shown in FIGS. 6A-6C, the data is available in the analysis (i.e., “iAnalyze”) cards, such as cumulative spending and the top five (5) spend categories that are configured as per the decision rules that are available to the iAnalyze user. Similarly, for other relevant cards, the data available in the one view system is based on the roles and authorization of the users.

As generally shown in FIG. 6A, when the user enters a search query (30) for a product, the search text (e.g., see element 1) is sent to the supplier information management (SIM) system that in turn sends the list of suppliers matching the search query (e.g., see element 2). Upon receiving the search results, the user is able to select supplier, supplier information or identification, user information with specified date range sent to all the products in order to fetch relevant product data from the respective products. Thus, the user is able to directly click on the required supplier's name instead of conducting separate searches for the supplier, thereby the user will get the desired product's information and its supplier information, supplier identification, user information, last selected date range, as well as default date range. The product specific data fetched (32) from all the products is displayed in the respective product information cards (e.g., see element 3), e.g., as generally shown in FIG. 6B.

The user is also able to further create a report (32) of the product search obtained using the one view system, whereby the user may click on a “More” option in order to generate the desired report (e.g., see element 4) having details such as contract number, event name, supplier product management, user information and selected date range, e.g., as generally shown in FIG. 6C. For example, if the user wants to drill down further to a report (e.g., a RMS report) from the one view system, the user may click on the “More” option, which will open up a new window and the required report may be displayed. The user may also navigate to specific product pages (e.g., view contracts, view SPM events and/or the like) by clicking on, for example, contract number and/or SPM event name, respectively. In both cases, (e.g., redirection to reports and product view page), the supplier information (e.g., supplier ID), user information and the selected date range are passed to the products. This avoids requiring the user to manually switch between products and drilling down to the required report. Thus, the described system and method provides consolidated data to the user at the end by generating a suitable report.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While considerable emphasis has been placed herein on the structures and structural interrelationships between the component parts of the preferred embodiments, it will be appreciated that many embodiments can be made and that many changes can be made in the preferred embodiments without departing from the principals of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. An integrated system for providing a consolidated view of multiple windows on a display device, wherein there is at least one configurable and namable business process element operable to be displayed on the display device, comprising:
a host computer system;
at least one database component operably associated with the host computer system;
a communication interface for accessing the host computer system from a plurality of remote input/output devices, wherein the input/output devices are operable to manage the consolidated view for the business process element;
a processor unit operably associated with the host computer system; and
a computer readable medium storing instructions executable by the processor unit, the computer readable medium comprising:
an accessing system for accessing, through one of the remote input/output devices, a first view of a supplier category or business unit information set on a display device of the remote input/output devices; and
a converting system for converting the first view of the supplier category or business unit information set to a second view of the supplier category or business unit information set on the display device of the remote input/output devices;
wherein the second view of the supplier category or business unit information set includes additional or different supplier category or business unit information than the first view of the supplier category or business unit information.

2. The system according to claim 1, wherein the converting system converts the first view of the supplier category or business unit information set to the second view of the supplier category or business unit information set on the display device of the remote input/output devices in response to a graphical user interface being positioned over a specified location of the display device of the remote input/output devices.

3. The system according to claim 2, wherein the positioning of the graphical user interface over a specified location of the display device of the remote input/output devices causes the processor unit to generate the second view of the supplier category or business unit information set on the display device of the remote input/output devices.

4. The system according to claim 1, wherein the first view of the supplier category or business unit information set and the second view of the supplier category or business unit information set on the display device of the remote input/output devices are displayed in separate windows on the display device of the remote input/output devices.

5. The system according to claim 1, wherein the first view of the supplier category or business unit information set and the second view of the supplier category or business unit information set on the display device of the remote input/output devices are simultaneously displayed in separate windows on the display device of the remote input/output devices.

6. The system according to claim 1, wherein the first or second view of the supplier category or business unit information set provides any one of a supplier report card, a supplier location on a map, a comment box and a date range selection system.

7. The system according to claim 1, wherein the first or second view of the supplier category or business unit information set provides a date range selection system.

8. The system according to claim 1, further comprising a report generation system, wherein a user has an option to view a supplier report in either a summary mode or a detail mode.

9. The system according to claim 1, wherein the first or second view of the supplier category or business unit information set provides an information card, wherein the information card provides information on any one of spend, contracts, supplier performance programs, sourcing events, purchase orders, and invoices for a selected time frame for a user specific supplier, category or business unit.

10. The system according to claim 1, wherein the second view of the supplier category or business unit information set provides a restricted viewing option preventing viewing of the second view of the supplier category or business unit information set to unauthorized users.
